(19) United States
(12) Patent Application Publication
(10) Pub. No.: US 2014/0248598 A1
(43) Pub. Date: Sep. 4, 2014

(54) METHOD FOR PROMOTING COLLECTIVE ACHIEVEMENT IN A COOPERATIVE GROUP

(71) Applicant: Sylvig Acuff, Little Elm, TX (US)

(72) Inventor: Sylvig Acuff, Little Elm, TX (US)

(21) Appl. No.: 13/783,379

(22) Filed: Mar. 3, 2013

(51) Int. Cl. G09B 7/00

(52) U.S. Cl. CPC G09B 7/00
USPC 434/353

(57) ABSTRACT

A method for promoting academic achievement in a group of individuals. The present disclosure is designed to enhance the effectiveness of scholarship programs through additional value-added services for scholarship candidates and recipients. The value-added services may include—but are not necessarily limited to—proactive intervention efforts such as mentoring, counseling and tutoring, social, teambuilding and leadership retreats, community-building programs, and alumni development.

### BACKGROUND OF THE DISCLOSURE

It is known that academic achievement in the United States has fallen behind that of other nations. Academic achievement in the United States is particularly weak within certain areas of the country and within certain demographic groups, but the problem of weak academic achievement affects the entire United States. Accordingly, there is a continuing need to provide new and innovative training methods to encourage and allow individuals to thrive in a variety of environments, including the home, school, workplace and society at large.

In the interest of promoting academic achievement, philanthropists and charitable organizations are known to offer scholarships to deserving students. Scholarships may be purely financial, or may include other benefits. Ideally, a scholarship removes a barrier—financial or otherwise—between an individual and the goals the individual has set for him or herself.

### SUMMARY OF THE DISCLOSURE

The present disclosure relates to a method for promoting academic achievement in a group of individuals. The present disclosure is designed to enhance the effectiveness of scholarship programs through additional value-added services for scholarship candidates and recipients. The value-added services may include—but are not necessarily limited to—proactive intervention efforts such as mentoring, counseling and tutoring, social, teambuilding and leadership retreats, community-building programs, and alumni development. The method is intended to offer a group of cooperative individuals a variety of study course modules in which all participants will have to meet goals and criteria to earn college preparatory courses and/or scholarships to higher learning institutions.

The training methodologies disclosed herein are specifically designed to help individuals visibly learn, track and earn tangible successes in life for themselves individually, as well as for their family. According to the disclosure, specific criteria must be met in order to qualify, which may include a formal commitment from at least one group leader. In certain variations, all group members above a certain level of authority or seniority must enter into a similar commitment to review and be evaluated on minimum allowable criteria, which may include a minimum threshold level of performance on course module studies chosen by participants or assigned by program managers. Multi-dimensional tracking methods are measured for both individuals in the group and also for the group as a whole entity to advance in the selection process.

Each participant is responsible for his/her own progress in the program but each evaluated participant is responsible to help keep other group participants accountable in the process along with coursework tracking managers.

The identified dimensions and the values assigned to those dimensions by the information flow data and metadata are used in enforcing policies that will regulate the advancement of participants for each coursework level. Systems and methods in accordance with the program provide for the propagation of different dimensions of information such that the different dimensions can be interdependent.

### BRIEF DESCRIPTION OF THE DRAWINGS

FIG. 1 is a block diagram of a curriculum plan for a group of individuals in a cooperative group;

FIG. 2 is a timeline chart showing curriculum plans for four individuals in a cooperative group;

FIG. 3 is a flowchart showing a method for evaluating and tracking academic performance of the members of an academic group;

FIG. 4 is a block diagram showing certain relationships between academic course units, academic goals, and individuals in a cooperative group;

FIG. 5 is a timeline showing curriculum lesson plans for a group of individuals in a cooperative academic group;

FIG. 6 is a chart showing program criteria for a cooperative academic program; and

FIG. 7 is a diagram showing a network operable to perform the method.

### DETAILED DESCRIPTION OF THE DRAWINGS

The present disclosure relates to a method for enhancing the academic achievement of certain members of a cooperative group. According to the method, the members of a selected subset of the group, or the group as a whole, are presented with certain academic content and required to demonstrate a certain minimum level of academic performance in order for one or more members of the group to advance through the program or to receive an identified benefit.

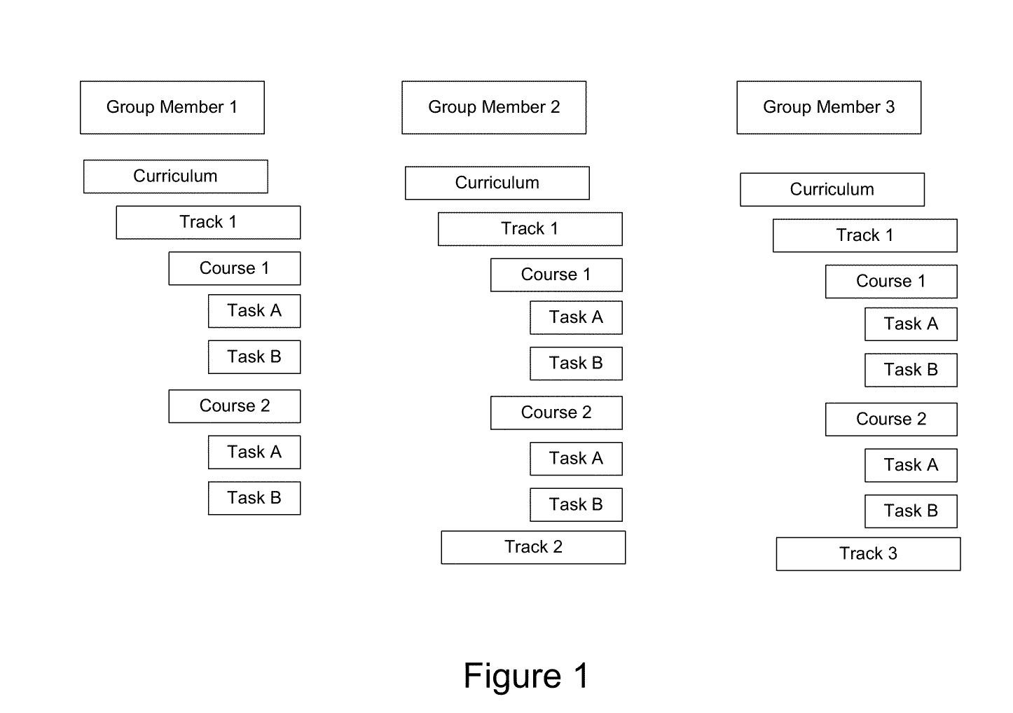

FIG. 1 is a block diagram of a curriculum plan for a group of individuals in a cooperative group. Each of Group Members 1-3 has a curriculum associated therewith. Group Member 1 is enrolled in Curriculum Track 1, which incorporates Course 1 and Course 2. Group Member 2 is also enrolled in Track 1, and thus is also enrolled in Courses 1 and 2. In addition, Group Member 2 is also enrolled in Track 2. Group Member 3 is, like Group Members 1 and 2, is enrolled in Track 1, and thus Courses 1 and 2. Group Member 3 is also enrolled in Track 3.

The content of Tracks 1, 2 and 3 may vary depending on the relationships of Group Members 1, 2 and 3. In general, Track 1 will be a curriculum track that has a broad application to members of the cooperative group. Tracks 2 and 3 offer more specialized content of specific relevance to Group Members 2 and 3, respectively.

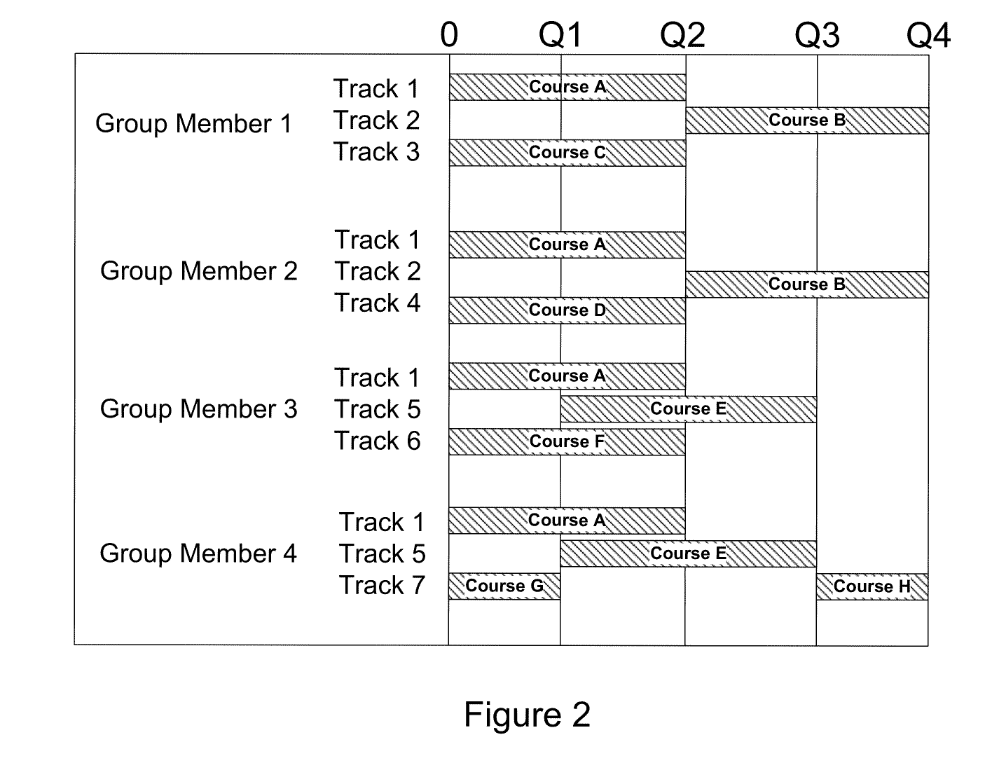

FIG. 2 is a timeline chart showing curriculum plans for four individuals in a cooperative group. Each of the members of the group has his or her own individualized curriculum comprising certain tracks. Certain of the members of the group participate in common tracks. In this example, each of the members of the group is involved in a specialized curriculum tailored to that group member.

Along the top of FIG. 2 is a set of evaluation points designated Q1, Q2, Q3 and Q4. Each of these evaluation points represents a point in time at which the group performance, individual performance, or both, are evaluated according to certain predetermined criteria. At these points, advancement of the individual group members is affected by the performance of the overall performance of the group, and not only by the performance of that individual participant.

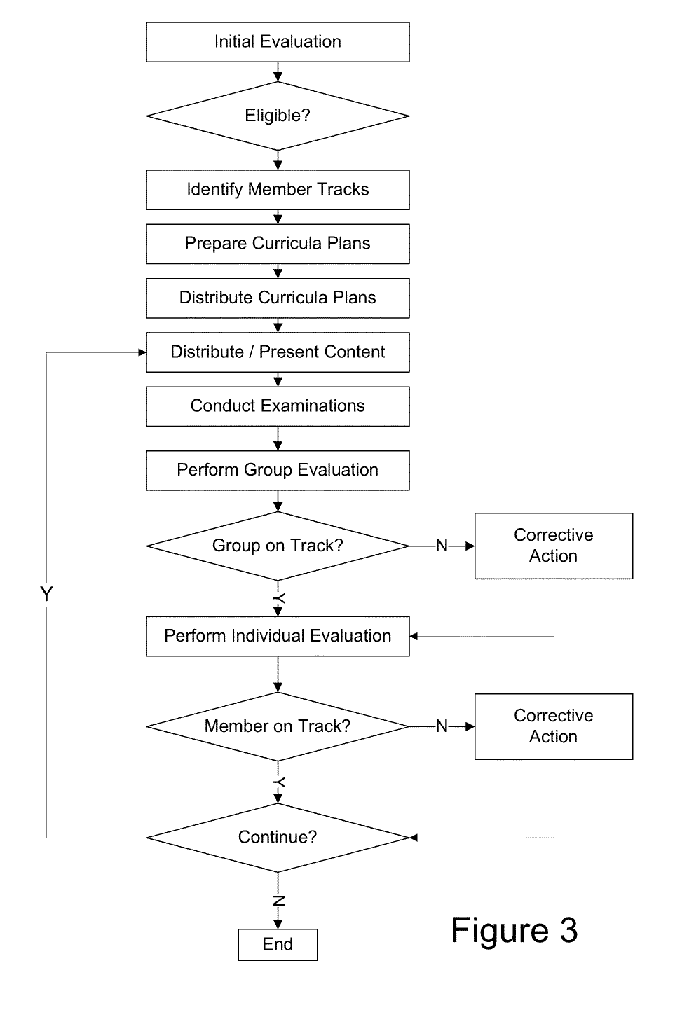

FIG. 3 is a flowchart showing a method for evaluating and tracking academic performance of the members of an academic group.

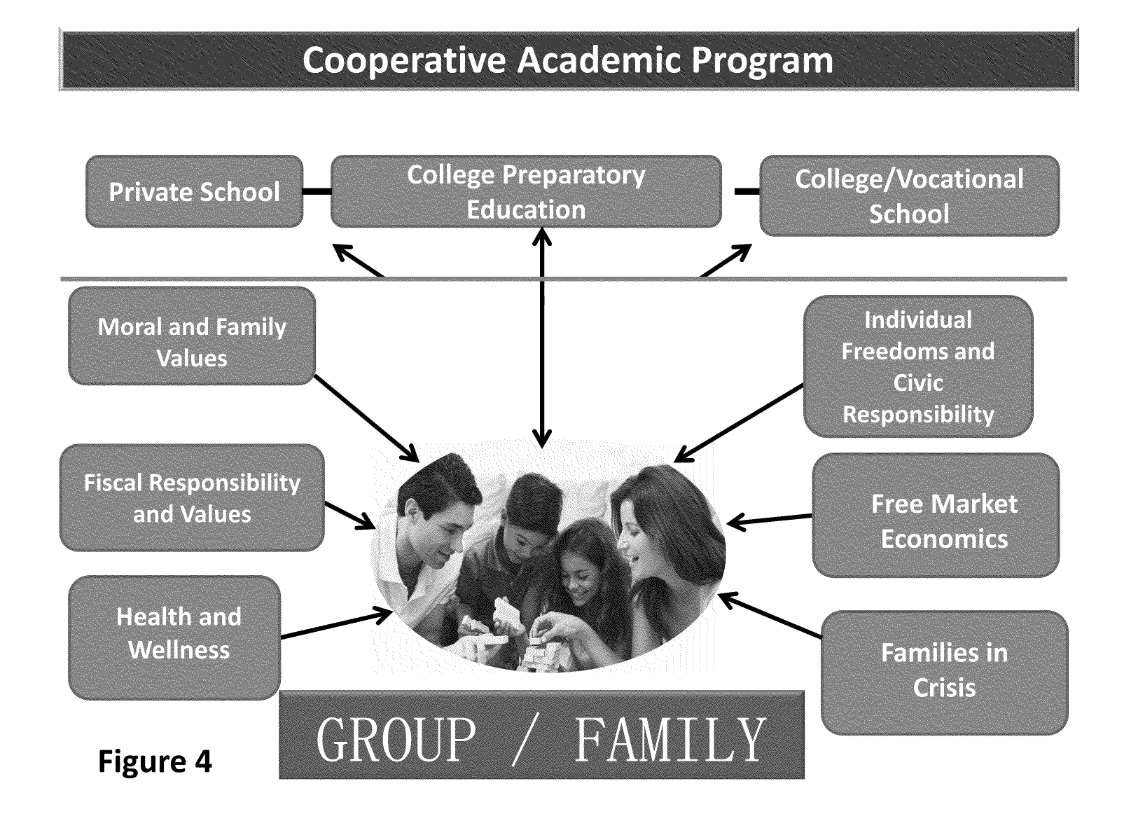

FIG. 4 is a block diagram showing certain relationships between academic course units, academic goals, and individuals in a cooperative group.

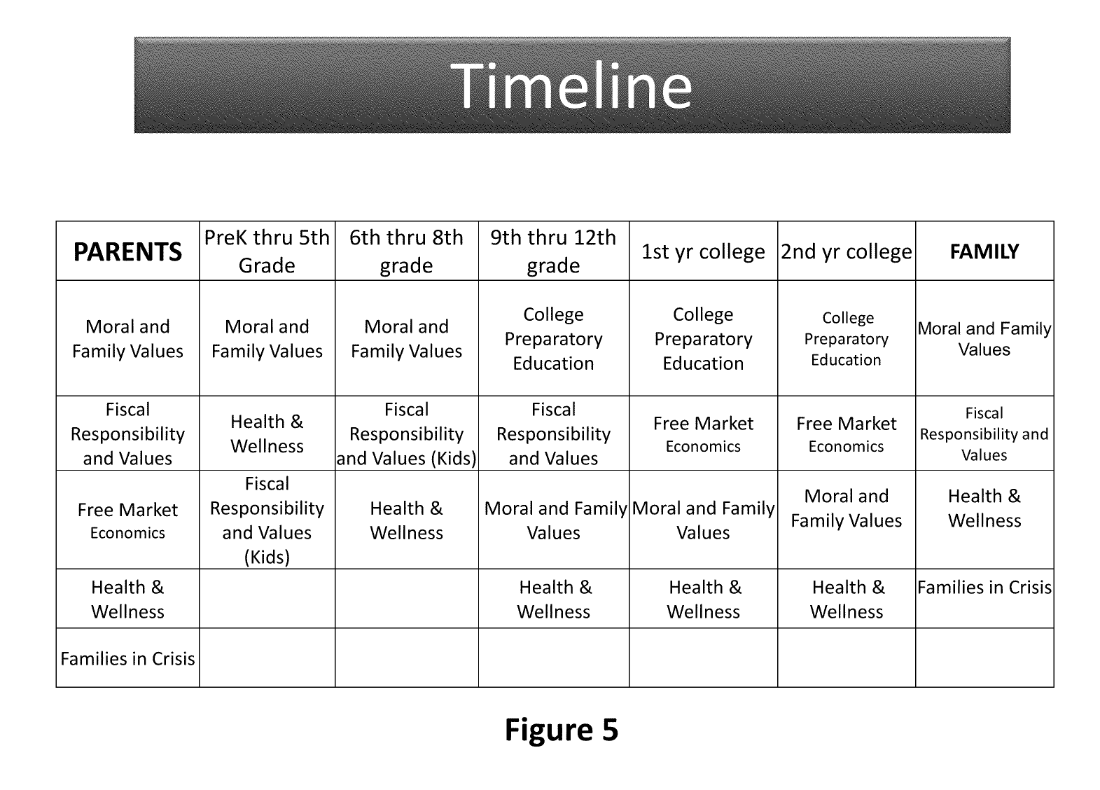

FIG. 5 is a timeline showing curriculum lesson plans for a group of individuals in a cooperative academic group.

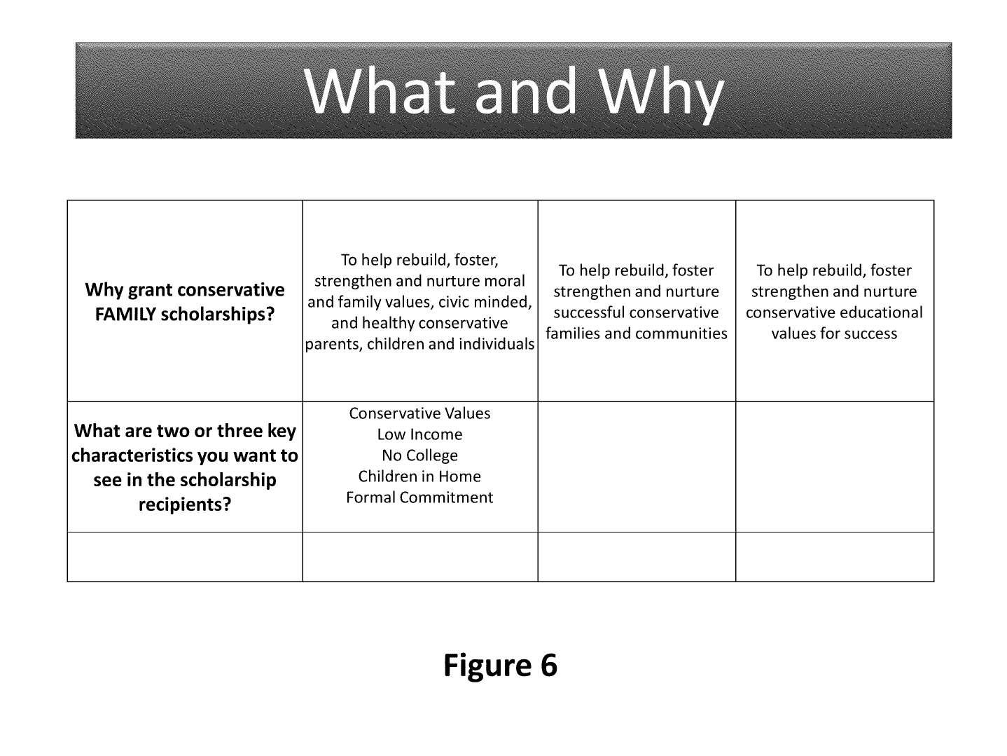

FIG. 6 is a chart showing program criteria for a cooperative academic program.

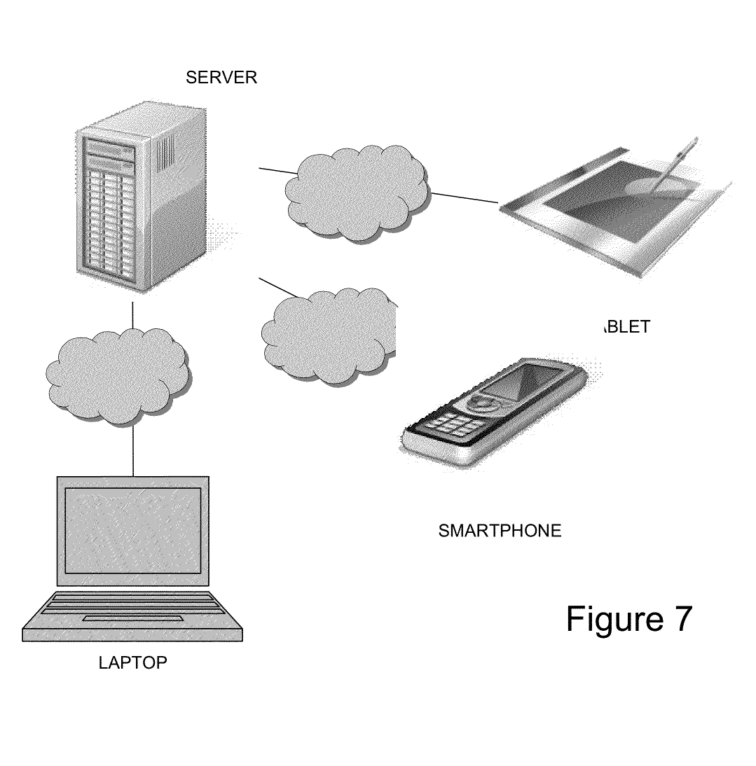

FIG. 7 is a diagram showing a network operable to perform the method. According to this embodiment, a server communicates with remote computers and devices over one or more networks. Participants in the cooperative academic program can use devices such as the laptop, smartphone and tablet to receive and review lesson materials, undergo academic evaluations, and report academic achievements. The server, in turn, can process the incoming information and compare the level of each member's performance to the pre-determined criteria to determine whether the member is performing according to the pre-determined criteria.

The server is also operable to analyze the ratings of the individual members of the group according to certain predetermined group performance criteria to determine whether the group is performing according to the minimum criteria. In the event that the group is not performing according to one or more minimum criteria, the group can be notified, along with one or more program managers, so that corrective action may be taken. If the corrective measures are not successful, the server may be operable to make a recommendation as to whether the group continues to be eligible to participate in the program.

Each participating member of the group is evaluated according to a variety of dimensions, which may include areas such as basic academic performance, general behavior, interpersonal skills, life-planning skills, participation in extracurricular activities, participation in counseling, or basic study skills, as examples. The members of the group, and the group as a whole, may be evaluated by any one or more of the above dimensions.

If the members of the group and the overall group are performing at levels at or above the minimum criteria, the server will continue to monitor group and individual performance to determine when the necessary milestones have been met for advancement of one or more group members and or provision of a benefit to an individual or the group.

The above teachings may, of course, be applicable to a wide variety of contexts, but according to at least one embodiment of the disclosed method, the cooperative group comprises the members of a family unit, and the benefit sought is a scholarship to participate in an academic or training program.

The following tables are examples of the types of reports that may be maintained and generated during the course of operation of the disclosed method. They are provided only by way of example, and those of skill in the art of teaching will recognize that a variety of such reports may be employed in the present method.

### Timeline

| | | | | | |
|---|---|---|---|---|---|
| PARENTS | Open | Open | Open | Open | Open |
| CHILDREN | PreK thru 5th | 6th thru 8th | 9th thru 12th | 1st yr college | 2nd yr college |
| | Grade | grade | grade | | |

### Tracking Methods

| FAMILY | | Monthly | | Comparison/Alternate | |
|---|---|---|---|---|---|
| A | SUBJECT COURSE 1 | GOALS | Intervention | Intervention | Outcomes |
| Parent1 | | | | | |
| Parent2 | | | | | |
| Child1 | | | | | |
| Child2 | | | | | |
| Child3 | | | | | |
| Child4 | | | | | |
| FAMILY | | Monthly | | Comparison/Alternate | |
| A | STUDY COURSE 2 | GOALS | Intervention | Intervention | Outcomes |
| Parent1 | | | | | |
| Parent2 | | | | | |
| Child1 | | | | | |
| Child2 | | | | | |
| Child3 | | | | | |
| Child4 | | | | | |
| FAMILY | | Monthly | | Comparison/Alternate | |
| A | SUBJECT COURSE 3 | GOALS | Intervention | Intervention | Outcomes |
| Parent1 | | | | | |
| Parent2 | | | | | |
| Child1 | | | | | |
| Child2 | | | | | |
| Child3 | | | | | |
| Child4 | | | | | |

### Metric Thresholds

| | | The Level | | | |
|---|---|---|---|---|---|
| | | Plane | | | |
| FAMILY A | | (Family as a | First | Second | Third |
| Participants | SUBJECT COURSE 1 | whole) | Dimension | Dimension | Dimension |
| Parent1 | | | | | |
| Parent2 | | | | | |
| Child1 | | | | | |
| Child2 | | | | | |
| Child3 | | | | | |
| Child4 | | | | | |
| | | The Level | | | |
| | | Plane | | | |
| FAMILY A | | (Family as a | First | Second | Third |
| Participants | SUBJECT COURSE 2 | whole) | Dimension | Dimension | Dimension |
| Parent1 | | | | | |
| Parent2 | | | | | |
| Child1 | | | | | |
| Child2 | | | | | |
| Child3 | | | | | |
| Child4 | | | | | |
| | | The Level | | | |
| | | Plane | | | |
| FAMILY A | | (Family as a | First | Second | Third |
| Participants | SUBJECT COURSE 3 | whole) | Dimension | Dimension | Dimension |
| Parent1 | | | | | |
| Parent2 | | | | | |
| Child1 | | | | | |
| Child2 | | | | | |
| Child3 | | | | | |
| Child4 | | | | | |

Similar embellishments, and various combinations thereof, are all comprehended by the present disclosure. In fact, all embodiments described herein are presented for purposes of illustration and explanation only. The specific compositions, configurations, orientations and operations of various features, portions and members may be provided in a number of ways in accordance with the present disclosure.

Thus, the embodiments and examples set forth herein are presented to best explain the present disclosure and its practical application and to thereby enable those skilled in the art to make and utilize the disclosure. As previously explained, those skilled in the art will recognize that the foregoing description and examples have been presented for the purpose of illustration and example only. The description as set forth is not intended to be exhaustive or to limit the disclosure to the precise form disclosed. Many modifications and variations are possible in light of the above teaching without departing from the spirit and scope of the following claims.

What is claimed is:

1. A method of for evaluating and tracking academic performance of the members of an academic group comprising the steps of:
performing an initial evaluation and
determining whether an applicant meets at least one eligibility criterion.
